(19) United States
(12) Patent Application Publication
(10) Pub. No.: US 2025/0332777 A1
(43) Pub. Date: Oct. 30, 2025

(54) Device for centering an extrusion die for extruding an extrusion material

(71) Applicant: Hans Weber Maschinenfabrik GmbH, Kronach (DE)

(72) Inventor: Rainer Vießmann, Kronach (DE)

(21) Appl. No.: 19/089,811

(22) Filed: Mar. 25, 2025

(30) Foreign Application Priority Data
Apr. 25, 2024 (DE) 102024111666.8

(51) Int. Cl. B29C 48/325; B29C 48/25

(52) U.S. Cl. CPC B29C 48/327; B29C 48/2528

(57) ABSTRACT

A device for centering an extrusion die for extruding an extrusion material wherein the device includes a housing means on or in which one or more centering elements are arranged or formed, wherein the one or more centering elements are configured to exert a centering force on an extrusion die to be centered, wherein the housing means comprises one or more fastening interfaces, by means of which the housing means can be fastened to an extrusion die to be centered or to an extrusion means comprising an extrusion die to be centered.

The present application is based upon and claims the right of priority to DE Patent Application No. 10 2024 111 666.8, filed Apr. 25, 2024, the disclosure of which is hereby incorporated by reference herein in its entirety for all purposes.

The invention relates to a device for centering an extrusion die for extruding an extrusion material, in particular a plastics material.

Corresponding devices for centering an extrusion die for extruding an extrusion material, such as an extrusion nozzle of an extrusion means, are known in principle from the prior art in various embodiments.

One example of a corresponding device for centering an extrusion die is described in the document DE 42 43 285 A1.

An area for improvement in the case of the known devices is in particular the fact that they are not suitable or configured for being able to be retrofitted to existing extrusion means which include one or more extrusion dies to be centered.

Proceeding herefrom, the object of the present invention is that of specifying a device for centering an extrusion die for extruding an extrusion material that is improved in comparison.

The object is achieved by a device for centering an extrusion die for extruding an extrusion material, in particular a plastics material, according to the present independent claim 1. The claims dependent thereon relate to possible embodiments of the device.

A first aspect of the invention relates to a device for centering an extrusion die for extruding an extrusion material, in particular a plastics material. The device is thus generally configured for centering an extrusion die for extruding an extrusion material, in particular a plastics material, e.g. an extrusion nozzle, which typically forms a component of an extrusion means. Centering of the extrusion die is in particular to be understood to mean orienting the extrusion die with respect to a reference axis, e.g. an axis of symmetry or central axis, of a component, in particular a rotationally symmetrical component, of an extrusion means, e.g. an extruder screw, an extruder cylinder or a corresponding pipe head. Specifically, orienting can include coaxially arranging an axis of symmetry or central axis of the extrusion die to be centered with respect to a corresponding reference axis.

The device includes one or more centering elements which are configured for exerting a centering force on an extrusion die to be centered. The one or more centering elements are thus configured to interact with an extrusion die to be centered, in order to bring about centering of the extrusion die. As emerges in the following, the device typically includes at least two centering elements which are configured to interact in order to exert a centering force on an extrusion die to be centered.

The device further includes a housing means, which can also be denoted for short as a housing, which is formed in one piece or in multiple parts. The one or more centering elements are typically arranged or formed on or in the housing means. For this purpose, the housing means can include a housing chamber, which can also be denoted a receiving chamber, on or in which in particular the one or more centering elements are arranged or formed. In addition, one or more further functional components of the device can be arranged or formed on or in the housing means, i.e. in particular on or in the housing chamber. The housing chamber can be closed to the outside, such that the functional components of the device arranged or formed in the housing chamber are protected against external influences, such as mechanical, thermal and/or climatic influences; thus, overall, a structurally highly integrated module is also provided.

The housing means includes one or more fastening interfaces, by means of which the housing means, i.e. in general the device, can be fastened to an extrusion die to be centered or to an extrusion means including an extrusion die to be centered. The fastening interfaces are thus configured for fastening the housing means or the device to an extrusion die to be centered or to an extrusion means including an extrusion die to be centered. This makes it possible, in a simple and practical manner, to also fasten the device on an existing extrusion die or an existing extrusion means including an extrusion die to be centered, and thus to retrofit this with the device, and thus in general the possibility for centering an extrusion die.

The one or more fastening interfaces can in particular be configured for fastening the housing means or the device to an extrusion die to be centered or to an extrusion means including an extrusion die to be centered, in a detachable manner, in particular detachable without damage or destruction. For this purpose, the one or more fastening interfaces can in particular be configured for fastening the housing means or the device to an extrusion die to be centered or to an extrusion means including an extrusion die to be centered, in a detachable manner, in particular detachable without damage or destruction, e.g. via form-fitting and/or force-fitting fastening means; thus, the one or more fastening interfaces can be e.g. form-fitting and/or force-fitting elements, or the one or more fastening interfaces can include one or more form-fitting and/or force-fitting elements. Corresponding form-fitting and/or force-fitting elements can e.g. be or include: clamping elements, latching elements, snap-in elements, tension elements, screw elements or rivet elements. The housing means or the device can thus be fastened to an extrusion die to be centered or to an extrusion means including an extrusion die to be centered e.g. via a clamping, latching, snap-in, tension, screw or rivet connection.

The housing chamber of the housing means can be configured to be ring-like or ring-shaped, or can have a ring-like or ring-shaped basic shape. Similar can also apply for the housing means, and thus the housing means can also be configured to be ring-like or ring-shaped, or can have a ring-like or ring-shaped basic shape. The cross-sectional geometry of the housing chamber or the housing means can be e.g. polygonal, in particular square; in this way, there is typically also sufficient space for arranging or forming the one or more centering elements, and optionally additional further functional components of the device, in the housing chamber.

The one or more centering elements can be configured as or include e.g. eccentric elements, i.e. e.g. eccentric rings. In particular, the device can include two eccentric elements that engage in one another, specifically a first eccentric element, which can optionally also be referred to as the inner eccentric element, and a second eccentric element, which can optionally also be referred to as the outer eccentric element. The first eccentric element can include or be configured as an eccentrically configured first ring or ring portion. The second eccentric element can likewise include or be configured as an eccentrically configured second ring or ring portion. The two eccentrically configured rings or ring portions are typically coupled together. In particular, the first ring or ring portion can be arranged inside the second ring or ring portion and in a manner contacting it on the inner peripheral side, such that, due to the eccentric geometry, turning of the first ring or ring portion, i.e. in general the first eccentric element, relative to the second ring or ring portion, i.e. in general the second eccentric element, has an effect on the second ring or ring portion, i.e. in general the second eccentric element, and vice versa. One or more sliding elements or surfaces or rolling bearings can be arranged or formed between the contact surfaces of the two rings or ring portions, i.e. in general the two eccentric elements, for example for reducing friction and wear.

The eccentric elements can each include one or more drive portions which are configured for interacting, e.g. by mechanical engagement, with a drive element assigned to a drive means, e.g. a band, a chain or a belt, in order to transmit a drive force, setting the respective eccentric element into a rotational movement, or a corresponding torque, to the respective eccentric element. Respective drive portions can thus be coupled to a drive element assigned to a drive means, optionally with interposition of a transmission means, in order to transmit a drive force, setting the respective eccentric element into a rotational movement, or a corresponding torque, to the respective eccentric element. Typically, each drive portion and thus each eccentric element is coupled independently to a drive element assigned to a drive means, in order to transmit a drive force, setting the respective eccentric element into a rotational movement, or a corresponding torque, to the respective eccentric element, such that the eccentric elements can in principle be set into rotation independently of one another.

It follows from the above that the eccentric elements, i.e. the rings or ring portions, can be turned relative to one another. The eccentric elements, i.e. the rings or ring portions, can thus be mounted so as to be rotatable about an axis of rotation, in particular a common axis of rotation, which can coincide e.g. with the axis of symmetry or central axis of the ring-like or ring-shaped housing means. In this case, the eccentric elements can be rotated in the same or in different directions of rotation.

In order to allow for a structurally compact implementation of the eccentric elements in view of integration both of corresponding rings or ring portions and of corresponding drive portions, the eccentric elements can have an L-like or L-shaped cross-sectional geometry, wherein respective eccentrically configured rings or ring portions can be arranged or formed on a portion that is radially (further) inwards with respect to the axis of rotation and respective drive portions can be arranged or formed on the portion that is radially (further) outwards.

As mentioned, the eccentric elements are typically coupled together, wherein the eccentrically configured first ring or ring portion can be arranged inside the eccentrically configured second ring or ring portion, in a manner contacting it on the inner peripheral side, such that, due to the eccentric geometry, turning of the first ring or ring portion relative to the second ring or ring portion has an effect on the second ring or ring portion, and vice versa. This can be achieved structurally, in view of a corresponding L-like or L-shaped cross-sectional geometry of the eccentric elements, e.g. in such a way that the second ring or ring portion, i.e. in general the second eccentric element, is arranged having its inner periphery on the outer periphery of the axially extending short portion of the first ring or ring portion, i.e. in general of the first eccentric element. The first ring or ring portion, i.e. in general the first eccentric element, can be arranged having its inner periphery, in particular slidably mounted, on a wall, in particular a wall forming a base, of the housing means.

At least one drive unit, which can be configured as or include e.g. an electric motor, can be arranged or formed on or in the housing means, which drive unit is configured for generating a centering force to be exerted on an extrusion die to be centered. In the light of the above explanations, it is conceivable for each centering element, i.e. each eccentric element, to be assigned its own drive unit, which is coupled to a particular eccentric element via a corresponding drive means, in order to transmit forces or torques which set the respective eccentric element into a rotational movement.

Respective drive units can thus be configured in general to generate a force or a torque which sets at least one centering element into a movement, in particular relative to a second centering element, preferably to a second centering element that is motion-coupled thereto. At least one centering element that can be or is set into a corresponding movement can be coupled via at least one movably mounted actuator, e.g. an adjustment pin (this can also be referred to or considered, in general, as a tension element) oriented radially with respect to the axis of rotation, to the extrusion die to be centered, such that a rotational movement of the at least one centering element results, via the at least one actuator, in a centering force exerted on the extrusion die to be centered. The centering force typically acts radially with respect to the axis of rotation, such that in this case the actuator is typically moved radially against the extrusion die to be centered, in particular radially against the outer periphery of the extrusion die to be centered, which enables centering of the extrusion die.

The at least one actuator can, in particular in the region of its free end, include an operative portion that is movable against the extrusion die to be centered, in particular radially with respect to an axis of symmetry of the extrusion die to be centered, in particular in order to exert a corresponding centering force on the extrusion die to be centered.

It emerges from the above explanations that the at least one centering element, this can be for example the second eccentric element mentioned above, can be or is mechanically coupled to the at least one actuator. In this case, the at least one actuator is typically mounted such that a rotational movement of the at least one centering element about an axis of rotation can be converted into a radial translational movement of the at least one actuator, with respect to the axis of rotation.

The at least one actuator can be mounted such that it is movable exclusively in a degree of freedom of movement over which it is movable against the extrusion die to be centered. A corresponding degree of freedom of movement can in particular be the radial translational movement of the at least one actuator, relative to the axis of rotation.

The at least one actuator can be arranged or formed detachably, in particular exchangeably, on or in the housing means. In this way, it is possible to easily configure the device differently, by providing actuators of different lengths, such that extrusion dies of different dimensions can be centered using the device. Similarly, the detachable arrangement or formation of the at least one actuator allows for simple replacement or exchange of an extrusion die.

The device can include a plurality of corresponding actuators, in particular arranged or configured in a manner distributed in the peripheral direction with respect to the ring-shaped geometry of the housing means. This not only provides advantages with respect to efficiency and precision of the centering, but rather a redundant design also increases the operational reliability of the device. In a specific embodiment, although given by way of example, the device can include three actuators that are arranged or configured in a manner distributed in the peripheral direction with respect to the ring-shaped geometry of the housing means.

A second aspect of the invention relates to an extrusion means for extruding an extrusion material, in particular a plastics material, wherein the extrusion means includes at least one extrusion die that can be or is to be centered, in particular an extrusion nozzle, and a device according to the first aspect of the invention that is assigned to the at least one extrusion die, and therefore all the statements in connection with the device apply analogously for the extrusion means.

The extrusion die that can be or is to be centered can e.g. be fastened to an e.g. pipe-like or pipe-shaped material outlet of an extrusion unit of the extrusion means including an extruder cylinder and at least one extruder screw that is at least rotatably mounted therein. The fastening of the extrusion die to the material outlet can be detachable and achieved e.g. by a screw fastening.

A further aspect of the invention relates to a method for centering an extrusion die for extruding an extrusion material, in particular a plastics material, wherein in the context of the method centering of the extrusion die with respect to a reference axis, in particular an axis of symmetry or a central axis of an extrusion means, is carried out by means of a device according to the first aspect of the invention, and therefore all the statements in connection with the device apply analogously for the extrusion means.

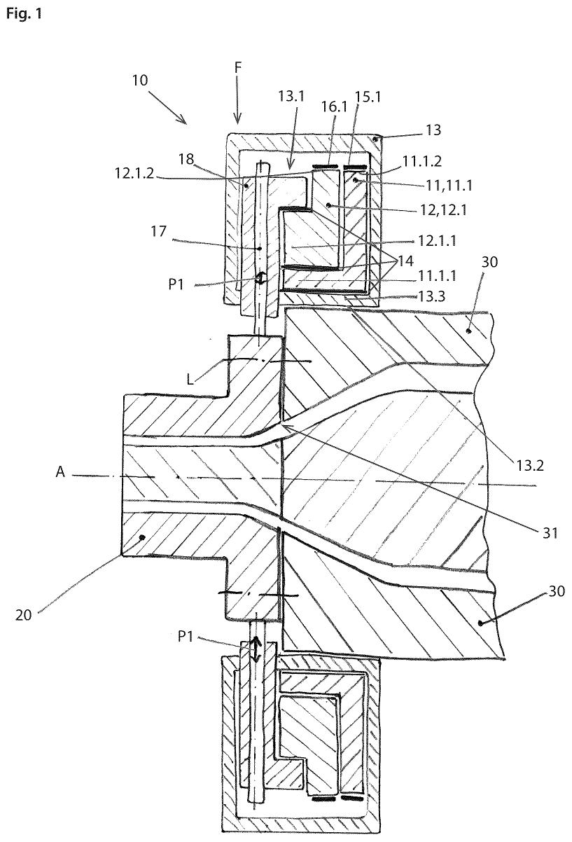

Further features and details of the invention will be explained again, by way of example, in the following, with reference to the embodiments shown in the figures. In this case, FIGS. 1 to 3 are each schematic views of a device for centering an extrusion die according to an embodiment.

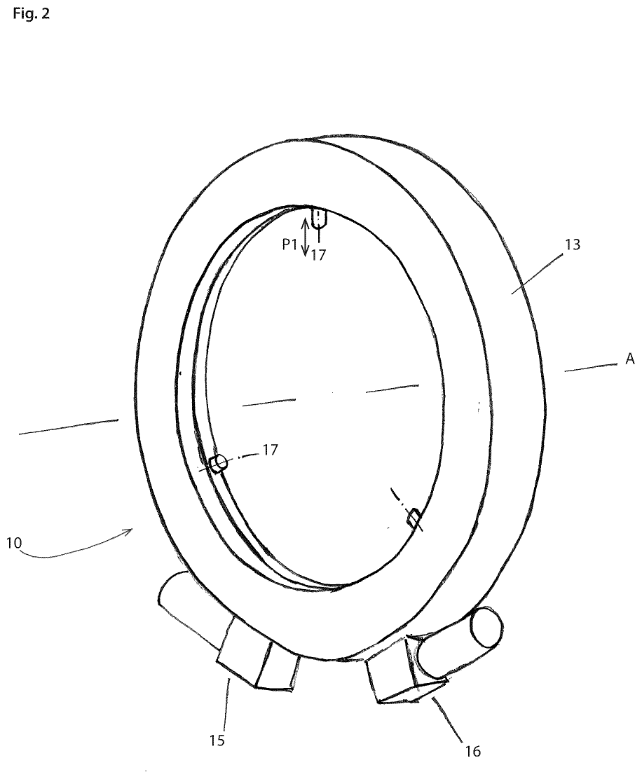

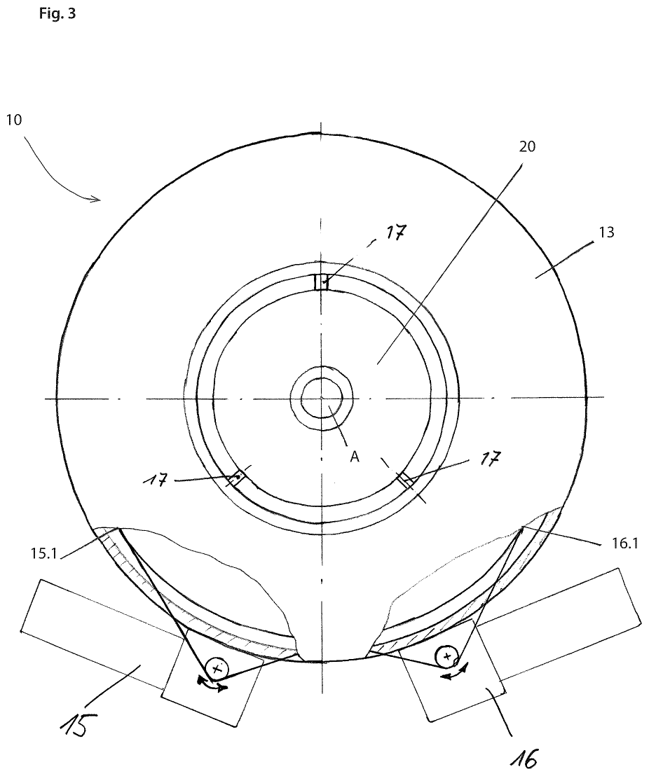

FIGS. 1 to 3 are each schematic views of a device 10 according to an embodiment, wherein the device 10 is shown in FIG. 1 in a cross-sectional view, in FIG. 2 in a perspective view, and in FIG. 3 in a front view.

The device 10 serves for centering an extrusion die 20 for extruding an extrusion material, in particular a plastics material. The device 10 is thus generally configured for centering an extrusion die 20 for extruding an extrusion material, in particular a plastics material, e.g. an extrusion nozzle, which typically forms a component of an extrusion means 30 that is indicated only in part in FIG. 1. Centering of the extrusion die 20 is in particular to be understood to mean orienting the extrusion die 20 with respect to a reference axis A, e.g. an axis of symmetry or central axis, of a component, in particular a rotationally symmetrical component, of the extrusion means 30, e.g. an extruder screw, an extruder cylinder or a pipe head. Specifically, orienting can include coaxially arranging an axis of symmetry or central axis of the extrusion die to be centered 20, with respect to a corresponding reference axis A.

In the embodiment, the device 10 includes two centering elements 11, 12 which are configured for exerting a centering force on the extrusion die 20 to be centered. The centering elements 11, 12 are thus configured to interact with the extrusion die 20 to be centered, in order to bring about centering of the extrusion die 20.

The device 10 further includes a housing means 13, which can also be denoted for short as a housing, which is formed in one piece or in multiple parts. In the embodiment, the centering elements 11, 12 are arranged or formed in the housing means 13. For this purpose, the housing means 13 includes a housing chamber 13.1, which can also be denoted a receiving chamber, on or in which in particular the centering elements 11, 12 are arranged or formed. In addition, one or more further functional components of the device 10 can be arranged or formed on or in the housing means 13, i.e. in particular on or in the housing chamber 13.1. The housing chamber 13.1 can be closed to the outside, such that the functional components of the device 10 arranged or formed in the housing chamber 13.1 are protected against external influences, such as mechanical, thermal and/or climatic influences; thus, overall, a structurally highly integrated module is also provided.

The housing means 13 includes one or more fastening interfaces 13.2, indicated purely schematically in FIG. 1, by means of which the housing means 13, i.e. in general the device 10, can be fastened to an extrusion die 20 to be centered or to an extrusion means 30 including an extrusion die 20 to be centered. The fastening interfaces 13.2 are thus configured for fastening the housing means 13 or the device 10 to an extrusion die 20 to be centered or to an extrusion means 30 including an extrusion die 20 to be centered. This makes it possible, in a simple and practical manner, to also fasten the device 10 on an existing extrusion die 20 or an existing extrusion means 30 including an extrusion die 20 to be centered, and thus to retrofit this with the device 10, and thus in general the possibility for centering an extrusion die 20.

The one or more fastening interfaces 13.2 can in particular be configured for fastening the housing means 13 or the device 10 to an extrusion die 20 to be centered or to an extrusion means 30 including an extrusion die 20 to be centered, in a detachable manner, in particular detachable without damage or destruction. For this purpose, the one or more fastening interfaces 13.2 can in particular be configured for fastening the housing means 13 or the device 10 to an extrusion die 20 to be centered or to an extrusion means 30 including an extrusion die to be centered 20, in a detachable manner, in particular detachable without damage or destruction, via form-fitting and/or force-fitting fastening means; thus, the one or more fastening interfaces 13.2 can be e.g. form-fitting and/or force-fitting elements, or the one or more fastening interfaces 13.2 can include one or more form-fitting and/or force-fitting elements. Corresponding form-fitting and/or force-fitting elements can e.g. be or include: clamping elements, latching elements, snap-in elements, tension elements, screw elements or rivet elements. The housing means 13 or the device 10 can thus be fastened to an extrusion die 20 to be centered or to an extrusion means 30 including an extrusion die 20 to be centered e.g. via a clamping, latching, snap-in, tension, screw or rivet connection.

It can be seen on the basis of an overview of FIGS. 1 and 2 that the housing chamber 13.1 of the housing means 13 can be configured to be ring-like or ring-shaped, or can have a ring-like or ring-shaped basic shape. Similar also applies, in the embodiment, for the housing means 13, and thus the housing means can also be configured to be ring-like or ring-shaped, or can have a ring-like or ring-shaped basic shape. In the embodiment, the cross-sectional geometry of the housing chamber 13.1 or the housing means 13 is, by way of example, polygonal, specifically square; in this way, there is sufficient space for arranging or forming the centering elements 11, 12, and optionally additional further functional components of the device 10, in the housing chamber 13.1.

In the embodiment, the centering elements 11, 12 are configured as or include eccentric elements 11.1, 12.1, i.e. eccentric rings. Specifically, in the embodiment, the device 10 includes two eccentric elements 11.1, 12.1 that engage in one another, specifically a first eccentric element 11.1, which can optionally also be referred to as the inner eccentric element, and a second eccentric element 12.1, which can optionally also be referred to as the outer eccentric element. The first eccentric element 11.1 can include or be configured as an eccentrically configured first ring or ring portion 11.1.1. The second eccentric element 12.1 can likewise include or be configured as an eccentrically configured second ring or ring portion 12.1.1. The two eccentrically configured rings or ring portions 11.1.1, 12.1.1 are coupled together. In particular, the first ring or ring portion 11.1.1 is arranged inside the second ring or ring portion 12.1.1 and in a manner contacting it on the inner peripheral side, such that, due to the eccentric geometry, turning of the first ring or ring portion 11.1.1, i.e. in general the first eccentric element 11.1, relative to the second ring or ring portion 12.1.1, i.e. in general the second eccentric element 12.1, has an effect on the second ring or ring portion 12.1.1, i.e. in general the second eccentric element 12.1, and vice versa. One or more sliding elements 14 or surfaces can be arranged or formed between the contact surfaces of the two rings or ring portions 11.1.1, 12.1.1, i.e. in general the two eccentric elements 11.1, 12.1, for example for reducing friction and wear.

It can furthermore be seen on the basis of FIG. 1 that the eccentric elements 11.1, 12.1 can each include a drive portion 11.1.2, 12.1.2 which are configured for interacting, e.g. by mechanical engagement, with a drive element 15.1, 16.1 assigned to a drive means 15, 16, e.g. a band, a chain or a belt, in order to transmit a drive force, setting the respective eccentric element 11.1, 12.1 into a rotational movement about an axis of rotation, cf. the reference axis A, or a corresponding torque, to the respective eccentric element 11.1, 12.1. Respective drive portions 11.1.2, 12.1.2 can thus be coupled to a drive element 15.1, 16.1, shown by way of example in FIGS. 2 and 3, assigned to a drive means 15, 16, optionally with interposition of a transmission means, in order to transmit a drive force, setting the respective eccentric element 11.1, 12.1 into a rotational movement, or a corresponding torque, to the respective eccentric element 11.1, 12.1. Typically, each drive portion 11.1.2, 12.1.2 and thus each eccentric element 11.1, 12.1 is coupled independently to a drive element 11.2, 12.2 assigned to a drive means 15, 16, in order to transmit a drive force, setting the respective eccentric element 11.1, 12.1 into a rotational movement, or a corresponding torque, to the respective eccentric element 11.1, 12.1, such that the eccentric elements 11.1, 12.1 can in principle be set into rotation independently of one another.

FIG. 3 shows, by way of example, how a corresponding drive element 15.1, 16.1 can be coupled to a corresponding drive means 15, 16. Specifically, FIG. 3 shows, by way of example, a configuration in which a corresponding drive element 15.1, 16.1 is coupled to an output element 15.2, 16.2, e.g. an output shaft, of the respective drive means, such that rotational movements of the output element 15.2, 16.2 lead to movements of the respective drive element 15.1, 16.1.

It follows from the above that the eccentric elements 11.1, 12.1, i.e. the rings or ring portions 11.1.1, 12.1.1, can be turned relative to one another. The eccentric elements 11.1, 12.1 can thus be mounted so as to be rotatable about an axis of rotation which typically forms a common axis of rotation for the eccentric elements 11.1, 12.1 and which can coincide e.g. with the axis of symmetry or central axis of the ring-like or ring-shaped housing means 13. In this case, the eccentric elements 11.1, 12.1 can be rotated in the same or in different directions of rotation.

In order to allow for a structurally compact implementation of the eccentric elements 11.1, 12.1 in view of integration both of corresponding rings or ring portions 11.1.1, 12.1.1 and of corresponding drive portions 11.1.2, 12.1.2, the eccentric elements 11.1, 12.1 can have an L-like or L-shaped cross-sectional geometry, as shown by way of example in FIG. 1, wherein respective eccentrically configured rings or ring portions 11.1.1 can be arranged or formed on a portion that is radially (further) inwards with respect to the axis of rotation and respective drive portions 11.1.2, 12.1.2 can be arranged or formed on the portion that is radially (further) outwards.

As mentioned, the eccentric elements 11.1, 12.1 are coupled together, wherein the eccentrically configured first ring or ring portion 11.1.1 can be arranged inside the eccentrically configured second ring or ring portion 12.1.1, in a manner contacting it on the inner peripheral side, such that, due to the eccentric geometry, turning of the first ring or ring portion 11.1.1 relative to the second ring or ring portion 12.1.1 has an effect on the second ring or ring portion 12.1.1, and vice versa. This can be achieved structurally, in view of a corresponding L-like or L-shaped cross-sectional geometry of the eccentric elements 11.1, 12.1, as shown in FIG. 1, in such a way that the second ring or ring portion 12.1.1, i.e. in general the second eccentric element 12.1, is arranged having its inner periphery on the outer periphery of the axially extending short portion of the first ring or ring portion 11.1.1, i.e. in general of the first eccentric element 11.1. The first ring or ring portion 11.1.1, i.e. in general the first eccentric element 11.1, can be arranged having its inner periphery, in particular slidably mounted, on a wall, in particular a wall 13.3 forming a base, of the housing means 13.

The corresponding drive units 15, 16, which can be configured as or include e.g. an electric motor, are arranged or formed on or in the housing means 13. As mentioned, in the embodiment each centering element, i.e. each eccentric element 11.1, 12.1, is assigned its own drive unit 15, 16, which is coupled to a particular eccentric element 11.1, 12.1 via a corresponding drive means 15.1, 16.1, in order to transmit forces or torques which set the respective eccentric element 11.1, 12.1 into a rotational movement. Specifically, FIG. 2 shows an arrangement, by way of example, of the drive units 15, 16 on the outer periphery of the housing means 13. The extrusion die 20 and also the extrusion unit are not shown in FIG. 2.

The drive units 15, 16 are thus configured, in general, to generate a force or a torque which sets a first centering element 11, 12 into a movement relative to the second centering element 12 coupled thereto, and/or vice versa. In the embodiment, the second centering element 12 is coupled via at least one movably mounted actuator 17, e.g. an adjustment pin (this can also be referred to or considered, in general, as a tension element) oriented radially with respect to the axis of rotation (cf. reference axis A) and shown schematically in the figure, to the extrusion die 20 to be centered, such that a rotational movement of the second centering element 12 results, via the at least one actuator 17, in a centering force F, indicated purely schematically in FIG. 1 by the arrow F, exerted on the extrusion die 20 to be centered. The centering force F thus acts radially with respect to the axis of rotation, such that the actuator 17 can be or is moved radially against the extrusion die 20 to be centered, in particular radially against the outer periphery of the extrusion die 20 to be centered, as indicated by the double arrow P1, which enables centering of the extrusion die 20.

The actuator 17 can include an operative portion that is movable against the extrusion die 20 to be centered, in particular radially with respect to an axis of symmetry of the extrusion die 20 to be centered that typically coincides with the reference axis A, in particular in order to exert a corresponding centering force on the extrusion die 20 to be centered.

It emerges from the above explanations that the at least one centering element 11, 12, this can be for example, as shown in the embodiment, the second eccentric element 12, can be or is mechanically coupled to the at least one actuator 17. In this case, the at least one actuator 17 is typically mounted such that a rotational movement of the centering element 12 about the axis of rotation can be converted into a radial translational movement of the at least one actuator 17, with respect to the axis of rotation, as is indicated in FIG. 1 by the double arrow P1.

The at least one actuator 17 can be mounted such that it is movable exclusively in the degree of freedom of movement, over which it is movable against the extrusion die 20 to be centered. The degree of freedom of movement can thus be the radial translational movement of the at least one actuator 17, relative to the axis of rotation.

The at least one actuator 17 can be arranged or formed detachably, in particular exchangeably, on or in the housing means 13. In this way, it is possible to easily configure the device 10 differently, by providing actuators 17 of different lengths, such that extrusion dies 20 of different dimensions can be centered using the device 10. Similarly, the detachable arrangement or formation of the at least one actuator 17 allows for simple replacement or exchange of an extrusion die.

The embodiment according to FIG. 1 shows, by way of example, that a replacement of the at least one actuator 17 is possible by opening the housing means 13 and in particular by detaching or fastening a centering disc 18, on which the actuator 17 is arranged or fastened.

The device 10 typically includes a plurality of corresponding actuators 17, in particular arranged or configured in a manner distributed in the peripheral direction with respect to the ring-shaped geometry of the housing means. This not only provides advantages with respect to efficiency and precision of the centering, but rather a redundant design also increases the operational reliability of the device 10. In a specific embodiment, although given by way of example, the device 10 can include three actuators 17 that are arranged or configured in a manner distributed in the peripheral direction with respect to the ring-shaped geometry of the housing means 13.

Finally, it can be seen on the basis of FIG. 1 that the extrusion die 20 that can be or is to be centered can e.g. be fastened to an e.g. pipe-like or pipe-shaped material outlet 31 of an extrusion unit of the extrusion means 30 including an extruder cylinder and at least one extruder screw that is at least rotatably mounted therein (neither shown). The fastening of the extrusion die 20 to the extrusion unit of the extrusion means 30 can be detachable and achieved e.g. by a screw fastening, indicated merely by the line L in FIG. 1.

The device 10 makes it possible to implement a method for centering an extrusion die 20 for extruding an extrusion material, in particular a plastics material, wherein in the context of the method centering of the extrusion die 20 with respect to a reference axis A, in particular an axis of symmetry or a central axis of an extrusion means 30, is carried out by means of the device 10.

1. A device for centering an extrusion die for extruding an extrusion material wherein the device comprises:
a housing means on or in which one or more centering elements are arranged or formed, wherein the one or more centering elements are configured to exert a centering force on an extrusion die to be centered, wherein the housing means comprises one or more fastening interfaces, by means of which the housing means can be fastened to an extrusion die to be centered or to an extrusion means comprising an extrusion die to be centered.

2. The device according to claim 1, wherein the one or more fastening interfaces are configured to releasably fasten the housing means to an extrusion die to be centered or to an extrusion means comprising an extrusion die to be centered.

3. The device according to either claim 1, wherein the housing means comprises a ring-like or ring-shaped housing chamber in which the one or more centering elements are arranged or formed.

4. The device according to claim 1, wherein the one or more centering elements are configured as or comprise eccentric rings that engage in one another.

5. The device according to claim 1, wherein at least one drive unit is arranged or formed on or in the housing means, which drive unit is configured for generating a centering force to be exerted on an extrusion die to be centered.

6. The device according to claim 5, wherein the at least one drive unit is configured to generate a force which sets at least one centering element into a movement relative to a second centering element that is motion-coupled thereto, wherein the centering element that can be set into a corresponding movement can be or is coupled to the extrusion die to be centered via at least one movably mounted actuator, such that a movement of the centering element that is set into a corresponding movement leads, via the at least one actuator, to a centering force exerted on the extrusion die to be centered.

7. The device according to claim 6, wherein the at least one actuator comprises an operative portion that is movable against the extrusion die to be centered radially with respect to an axis of symmetry of an extrusion die to be centered in order to exert a corresponding centering force on the extrusion die to be centered.

8. The device according to either claim 6, wherein the centering element that can be set into a corresponding movement can be or is coupled mechanically to the at least one actuator.

9. The device according to claim 6, wherein the actuator is arranged or fastened on a centering disc.

10. The device according to claim 6, wherein the at least one actuator is movable exclusively in a degree of freedom of movement over which it is movable against the extrusion die to be centered.

11. The device according to claim 6, wherein the at least one actuator is arranged or formed detachably on or in the housing means.

12. The device according to claim 6, comprising a plurality of actuators arranged or formed so as to be distributed in the peripheral direction with respect to an annular geometry of the housing means.

13. An extrusion means for extruding an extrusion material, wherein the extrusion means comprises: at least one extrusion die and a device according to claim 1 that is assigned to the at least one extrusion die.

14. A method for centering an extrusion die for extruding an extrusion material, wherein in the context of the method centering of the extrusion die with respect to a reference axis is carried out by means of a device according to claim 1.
